(19) United States
(12) Patent Application Publication
(10) Pub. No.: US 2026/0183980 A1
(43) Pub. Date: Jul. 2, 2026

(54) IMPACT REDUCTION SAW BLADE AND POWERABLE SAW INCLUDING SAME

(71) Applicant: GENERAL TOOL, INC., Irvine, CA (US)

(72) Inventor: Tae Min UM, Irvine, CA (US)

(73) Assignee: GENERAL TOOL, INC., Irvine, CA (US)

(21) Appl. No.: 19/422,831

(22) Filed: Dec. 17, 2025

Related U.S. Application Data
(60) Provisional application No. 63/739,062, filed on Dec. 26, 2024.

(51) Int. Cl. B26D 1/14; B26D 1/00

(52) U.S. Cl. CPC B26D 1/14; B26D 1/0006; B26D 2001/0046

(57) ABSTRACT

A saw blade for a powerable circular saw including a circular blade including an outer circumferential surface, the outer circumferential surface including a plurality of cutting edges, an inner circumferential surface defining a central aperture, the central aperture being configured to fix the blade on a rotatable shaft of the circular saw, and at least one resilient member located between the shaft and the inner circumferential surface, the at least one resilient member being configured to provide resilience between the inner circumferential surface and the shaft.

### FIELD OF THE INVENTION

The disclosure relates to saw blades used in powerable circular saws, including, for example, blades with steel cutting edges, diamond saw blades in segmented format, diamond brazed format, and continuous rim format for cutting various materials such as, for example concrete, stone and asphalt.

### BACKGROUND OF THE INVENTION

When conventional blade cutting edges make initial contact with a material to be cut, the force of the impact may damage and/or increase wear to the blades cutting edges, or for diamond saw blades, the diamond segments, or diamonds on the edges of the blade. As a result, the blade's cutting effectiveness and working lifespan may be shortened. Recoil of the saw may be experienced by the user operator thereby increasing fatigue and reducing the precision of the operator's control of the powerable saw to which the blade is attached. This can increase costs, reduce productivity, and increase the likelihood of injury. The exemplary embodiments of the disclosure reduce the impact on the blade cutting edges at initial contact. This may extend the working life of the blade and reduces the recoil transferred to the user. This can reduce worker fatigue and allow more precise control of the powerable saw, thereby increasing safety and productivity. It also reduces damage to diamond saw blades by extending the life of the diamond segments and diamonds brazed on to the blade.

### SUMMARY OF THE INVENTION

The disclosure incorporates an impact reducing feature that minimizes the initial impact when a blade, used in for example, a powerable circular saw using a rotating blade, contacts a material to be cut. By reducing the initial impact, the stress on the blade may be reduced. For diamond saw blades, the chances of losing or damaging the diamonds on the blade is reduced. The life of the blade may be extended, and stress felt by the operator is reduced. The design of the disclosure may also reduce noise and vibration of the saw blade during operation, which further contributes to reducing operator fatigue. Increased blade life can reduce costs to the user and increase profitability.

In an exemplary embodiment of the disclosure, a saw blade for a powerable circular saw may include a circular blade including an outer circumferential surface, the outer circumferential surface including a plurality of cutting edges, an inner circumferential surface defining a central aperture, the central aperture being configured to fix the blade on a rotatable shaft of the circular saw and at least one resilient member located between the shaft and the inner circumferential surface, the at least one resilient member being configured to provide resilience between the inner circumferential surface and the shaft.

In an exemplary embodiment of the disclosure, the at least one resilient member is a spring. The spring may be formed of any suitable material considering the application of the powered saw and the environment in which it is used. For example, high-carbon spring steels, alloy spring steels, stainless spring steels for heavier applications, copper-base spring alloys, nickel base spring alloys or suitable plastics for relatively lighter applications. In various exemplary embodiments the at least one resilient member may be at least one leaf spring, at least one coil spring or a plurality leaf or coil springs. In various exemplary embodiments, the resilient member may be any suitable resilient material that can absorb the initial impact.

In an exemplary embodiment of the disclosure, the saw blade may include an outer core. The outer circumferential surface and the central aperture may be located on the outer core. An inner core is located within the central aperture of the outer core. The inner core includes a bore configured to retain the shaft, wherein the resilient member is located between the inner core and outer core.

In an exemplary embodiment of the disclosure, the inner core may include a central portion having a plurality of first teeth extending radially outward and configured to transmit a torque of the shaft to the blade, and a plurality of first gap portions located between the teeth and configured to retain the at least one resilient member.

In an exemplary embodiment of the disclosure, the inner circumferential surface may include a plurality of second teeth that correspond to and engage the plurality of first gap portions and a plurality of second gap portions that correspond to and engage the plurality of first teeth.

In an exemplary embodiment of the disclosure, the at least one resilient member may be a leaf spring having an arced section and first and second fixed sections at respective first and second terminal ends, the first and second fixed sections being fixed to the first gap portions

In an exemplary embodiment of the disclosure, each first gap portion may include a groove provided at each opposite end, the first and second fixed sections being tabs inserted in the grooves. The fastening structure may be any suitable fastening structure to retain the resilient member withing the gap portion. The tension of the resilient member may provide enough force to fix the resilient member in the gap portion. Alternatively, it may be desirable to fix the resilient member withing the gap portion, such as by forming through holes at the first and second fixed section for the insertion of bolts to be retained by nuts.

In an exemplary embodiment of the disclosure, the saw blade may include a first hub located on a first side of the inner core and a second hub located on a second side of the inner core opposite to the first side. The first hub and the second hub are configured to retain the at least one resilient member on the saw blade.

In an exemplary embodiment of the disclosure, the hubs are larger than the central aperture. In an exemplary embodiment of the disclosure, the hubs are welded to the inner core.

In an exemplary embodiment of the disclosure, a tool head for a powerable power tool may include a circular working disk including an outer circumferential surface, the outer circumferential surface including a plurality of work edges, an inner circumferential surface defining a central aperture, the central aperture being configured to fix the blade on a rotatable shaft of the circular working disk, and at least one resilient member located between the shaft and the inner circumferential surface, the at least one resilient member being configured to provide resilience between the inner circumferential surface and the shaft. In an exemplary embodiment according to the disclosure the working disk is one of, for example, a grinder or a sander.

In an exemplary embodiment of the disclosure, powerable tool includes a saw blade or working disk having at least one of the features of the previously disclosed exemplary embodiments. The powerable, tool can be powered by any suitable power source, can be stationary or portable by one or two individuals. Examples include but are not limited to, a circular saw, a grinder, a sander.

Further scope of applicability of the present application will become more apparent from the detailed description given hereinafter. However, it should be understood that the detailed description and specific examples, while indicating preferred embodiments of the disclosure, are given by way of illustration only, since various changes and modifications within the spirit and scope of the disclosure will become apparent to those skilled in the art from the detailed description.

### BRIEF DESCRIPTION OF THE DRAWINGS

The present disclosure will become more fully understood from the detailed description given hereinbelow and the accompanying drawings which are given by way of illustration only, and thus are not limitative of the present disclosure.

FIG. 1 is a view of a saw blade according to an exemplary embodiment of the disclosure;

FIG. 2 is a view of the outer core according to an exemplary embodiment of the disclosure;

FIG. 3 is a view of the inner core according to an exemplary embodiment of the disclosure;

FIG. 4 is an enlarged view of the central aperture of the outer core, and the inner core according to an exemplary embodiment of the disclosure;

FIG. 5 is a view of a set of the springs according to an exemplary embodiment of the disclosure;

FIG. 6 is an isometric view of a spring according to an exemplary embodiment of the disclosure;

FIG. 7 is a view of a hub according to an exemplary embodiment of the disclosure;

FIG. 8A is an isometric view of a set of two hubs and the inner core according to an exemplary embodiment of the disclosure and FIG. 8B is an exploded view of a set of two hubs to be positioned on an inner core according to an exemplary embodiment of the disclosure;

FIG. 9 is an isometric view of a brazed diamond blade according to an exemplary embodiment of the disclosure;

FIG. 10 is a view of continuous rim blade according to an exemplary embodiment of the disclosure;

FIG. 11 is an isometric view of continuous rim blade according to an exemplary embodiment of the disclosure;

FIG. 12 is a view of a segmented blade according to an exemplary embodiment of the disclosure;

FIG. 13 is an isometric view of a segmented blade according to an exemplary embodiment of the disclosure;

FIG. 14 is modified version of the inner and outer core parts according to an exemplary embodiment of the disclosure; and

FIG. 15 is an isometric view of a powerable saw for use with the saw blade according to the exemplary embodiments of the disclosure.

### DETAILED DESCRIPTION OF THE INVENTION

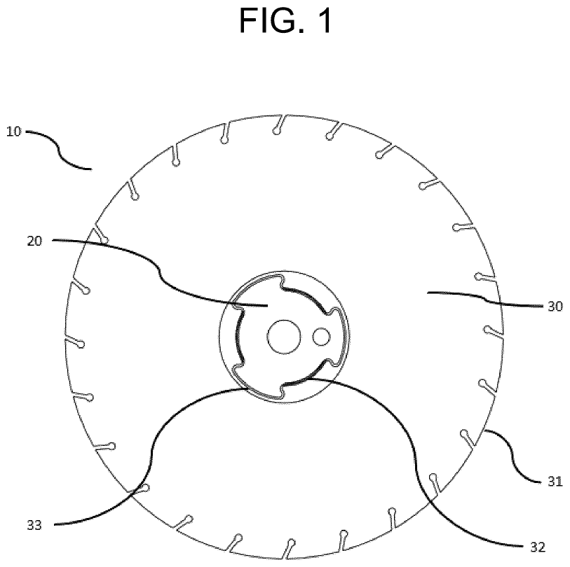

According to an exemplary embodiment of the disclosure as shown in FIG. 1, a circular saw blade 10 has an outer core 30 and an inner core 20 retained within a central aperture 32 of the outer core 30. The blade 10 has a plurality of cutting edges located on an outer circumferential edge 31 of the outer core. An inner circumferential surface 33 of the outer core 30 defines the central aperture 32. The outermost radius of the inner core 20 is less than a radius of the central aperture 32 to create a space between the outer circumferential surface 21 of the inner core 20 and the inner circumferential surface 33 of the outer core 30 defining the central aperture 32. The inner core 20 is held in the central aperture 32 by a resilient member 40, such as a spring, as will be explained below. The inner core 20 is able to move relative to the outer core 30 but the resilient member 40 biases the inner core 20 to an original position, for example, centered in the central aperture 32. The ability of the inner core 20 to move relative to the outer core 30 reduces recoil upon initial contact with the material to be cut, thereby minimizing the impact on the blade 10.

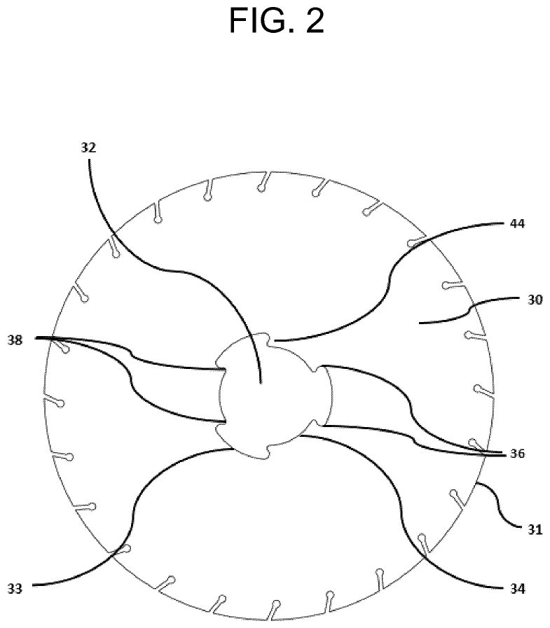

The outer core 30 is seen in an exemplary embodiment in FIG. 2. The outer core 30 includes the outer circumferential edge 31, the inner circumferential surface 33 and the central aperture 32. The outer circumferential edge 31 of the outer core 30 forms the cutting edge. The shape of the central aperture 32 corresponds to the shape of the inner core 20. As seen in FIG. 2, the central aperture 32 has a central section 34 and a plurality of teeth 36 extending radially inward and gaps 38 formed between the teeth 36. The shape of the teeth 36 and the gaps 38 correspond to the shape of teeth 24 and gaps 28 formed on the outer circumferential surface 21 of the inner core 20.

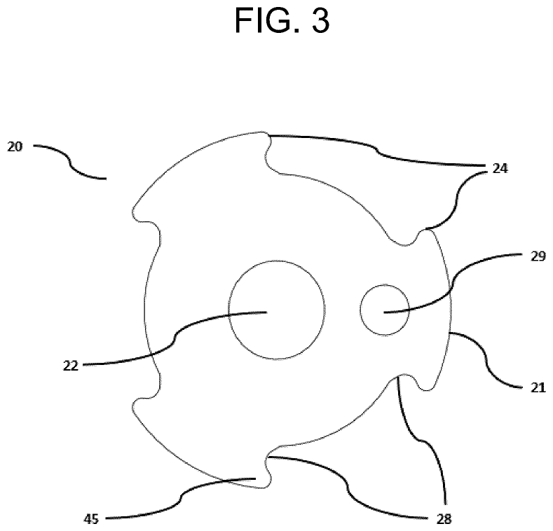

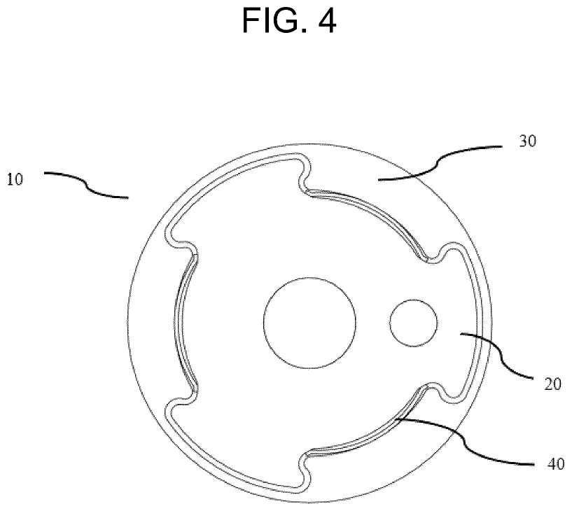

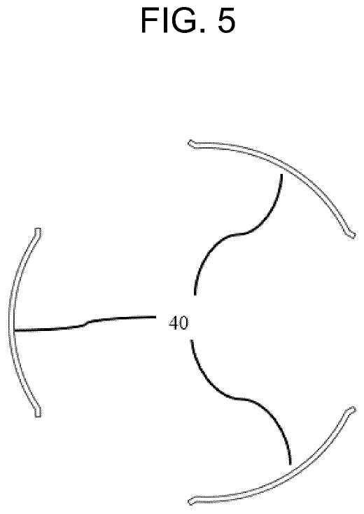

As seen in FIG. 3, the inner core 20 has a central aperture 22 for the insertion of a rotatable shaft coupled to the powerable saw. The inner core 20 has a circular central section with a plurality of teeth 24 formed on the outer circumferential surface. Transitions between the teeth 24 form gaps 28 between the plurality of teeth 24. The teeth 24 are shaped to fit into the gaps 38 formed in the inner circumferential surface 33 of the outer core 30. The teeth 36 formed in the inner circumferential surface 33 of the outer core 30 are shaped to fit into the gaps 28 formed in the outer circumferential surface 21 of the inner core 20. The meshing of the teeth 24, 36 and gaps 28,38 allows for efficient and reliable transfer of torque from the shaft of the powerable saw to the inner core 20, and to the outer core 30 having the cutting edge. Three teeth and corresponding gaps are depicted in FIG. 4, but any suitable number can be used. The inner core 20 also has pin hole 29 to prevent slippage from rotational forces. The central aperture 32 in the outer core 30 has a shape corresponding to the inner core 20 to have a space of substantially uniform width (0-15% variance) between the inner core 20 and outer core 30.

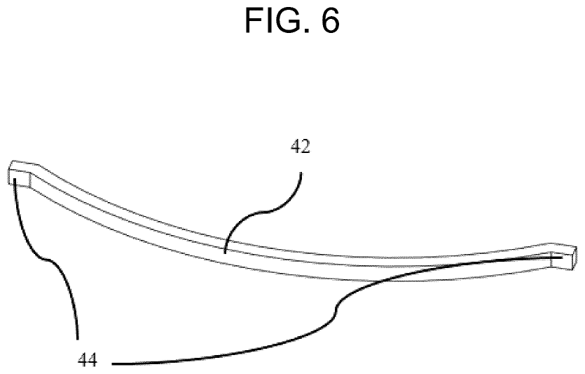

As seen in FIG. 4, a resilient member 40 may be located in the gaps 28 between the teeth 24 of the inner core 20 so that one resilient member 40 is retained between adjacent teeth 24 of the inner core 20. As shown in FIGS. 5 and 6, the resilient member 40, according to an exemplary embodiment of the disclosure, may be a leaf spring having a concave central potion 42 and two opposite ends 44. When installed (as shown in FIG. 1), an exterior facing side of the central portion 42 bears against the inner circumferential surface 33 of the outer core 30. An interior facing side of the ends 44 bears against the inner core 20 and an exterior facing side of the ends 44 bears against the inner circumferential surface 33 of the outer core 30. There is space between the inner circumferential surface 33 of the outer core 30 and the inner core 20 to allow the resilient member 40 to flex, thereby absorbing impact.

FIG. 5 depicts three resilient members 40 which are to be retained in the gaps 28 between the teeth 24 of the inner core 20. The ends 44 enhance the grip between the resilient members 40 and the inner core 20 and outer core 30. In an exemplary embodiment of the disclosure each gap 28 may include a groove 45 provided at each opposite end. The ends 44 may be first and tabs inserted in the grooves 45. In an exemplary embodiment of the disclosure, the fastening structure may be any suitable fastening structure to retain the resilient member 40 withing the gap 28. The tension of the resilient member 40 may provide enough force to fix the resilient member 40 in the gap 28. Alternatively, it may be desirable to fix the resilient member 40 withing the gap 28, such as by forming through holes at the ends 44 for the insertion of bolts to be retained by nuts.

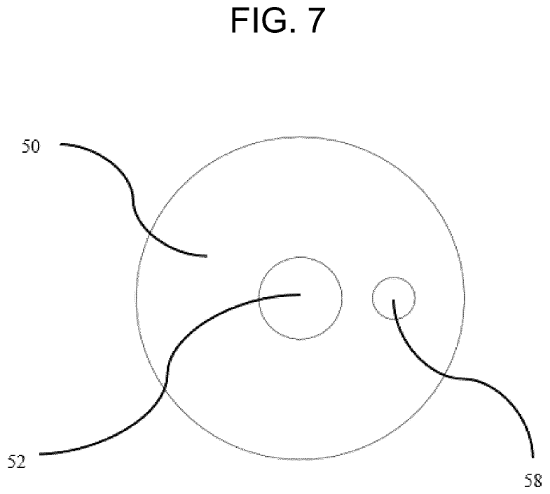

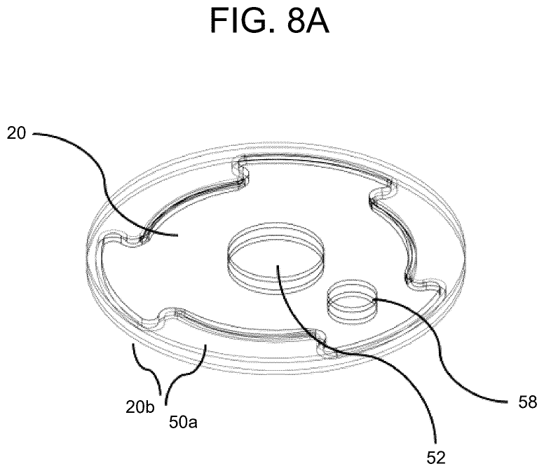

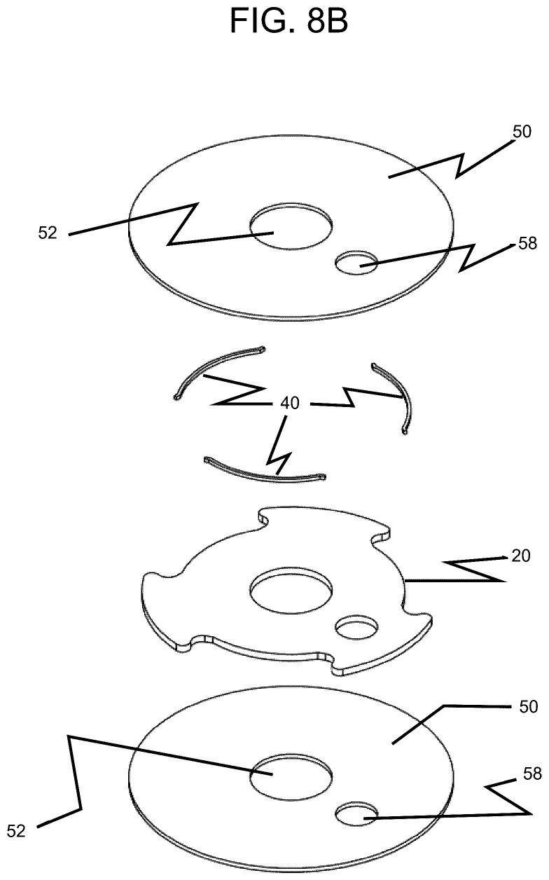

Once the inner core 20 is retained within the central aperture 32, hubs 50 can be attached to both sides of the blade 10 to prevent movement of the resilient members 40. An exemplary embodiment of the hubs 50 according to the disclosure is depicted in FIG. 7. FIG. 8A is an isometric view of a set of two hubs 50 and the inner core according to an exemplary embodiment of the disclosure and FIG. 8B is an exploded view of a set of two hubs 50 to be positioned on an inner core 20 with resilient members 40 according to an exemplary embodiment of the disclosure. The central aperture 22 of the inner core 20 aligns with central apertures 52 in the hub to allow for the attachment of the blade 10 and the hubs 50 to the powerable saw. The hub 50 also has a pin hole 58 aligning with the pin hole 28 of the inner core. The hubs 50 have a size greater than the central aperture and are secured to the blade through any suitable method. For example, the hubs 50 may attached to opposite sides of the inner core 20 by welding, for example, by threaded bolts passing through bore holes formed in the inner core 20, bayonet mounts, and adhesive. The hubs 50 protect the inner core 20 and can prevent debris from entering the area which hold the resilient members 40 and prevent the resilient members 40 from being displaced.

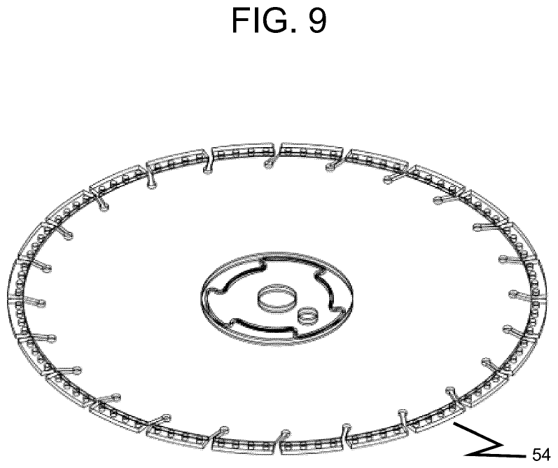

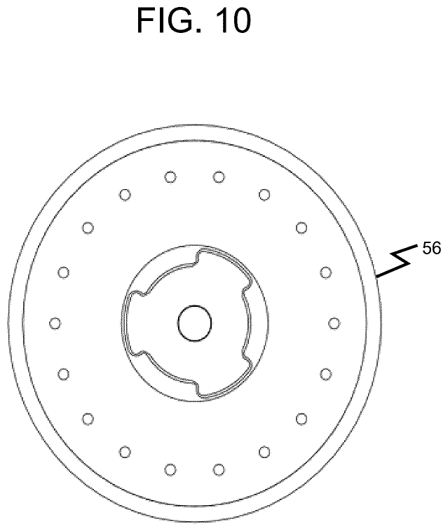

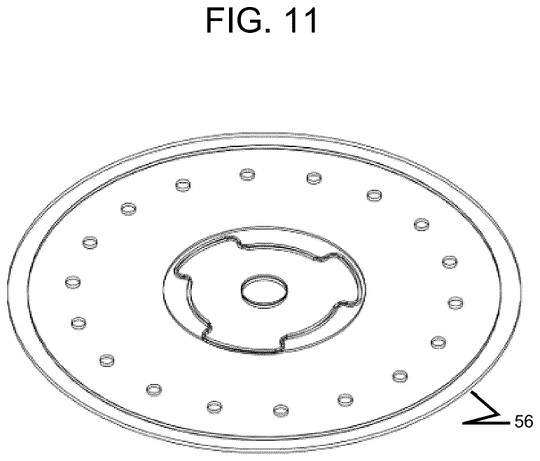

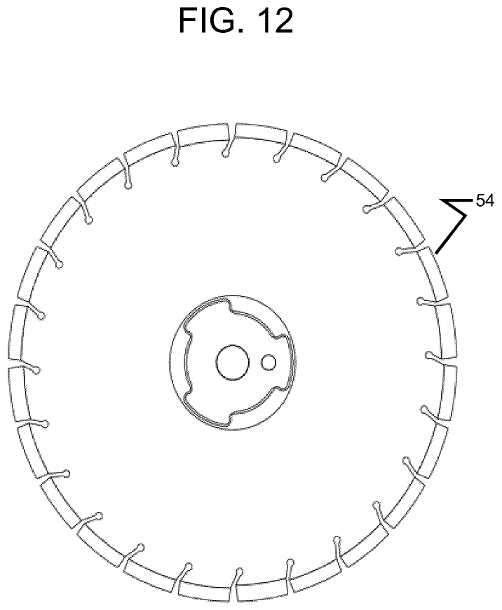

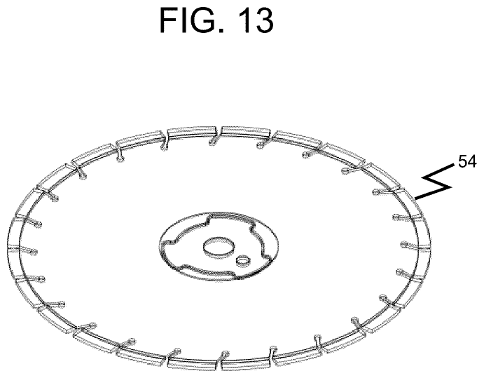

FIGS. 9, 12 and 13 depicts a blade 10 having cutting teeth 54, such as diamond cutting teeth, while FIGS. 10 and 11 depict a blade 10 having a smooth cutting edge. Both saws using the inner core 20 and outer core 30 which allow relative movement between the cores.

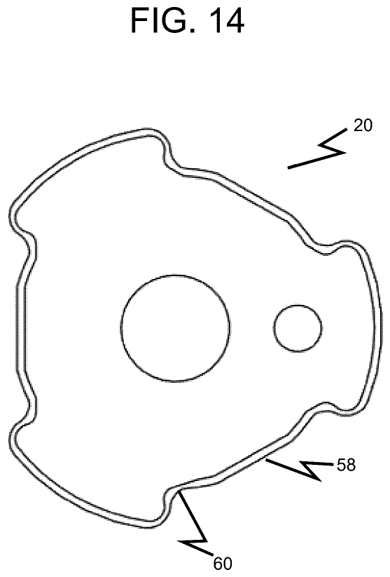

FIG. 14 depicts an alternative structure for the inner core 20. The central sections 58 between the teeth are flattened and the gap 60 between the central section and teeth are more pronounced.

In an exemplary embodiment of the disclosure the outside core 30 and the inside 20 core are laser cut to achieve precise fitting and alignment of the components.

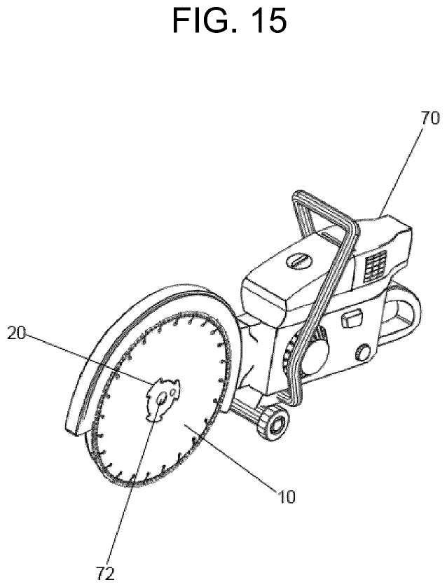

As shown in FIG. 15, the blades according to the various exemplary embodiments of the disclosure may be used with a powerable saw 70 including a rotatable shaft 72 on which the inner core 20 may be fixed to transmit rotational force to the blade 10.

Table 1 depicts experimental results comparing a conventional blade to a blade according to an exemplary embodiment of the disclosure. As shown by the experimental results the blades according to an exemplary embodiment of the disclosure have reduced vibration acceleration and lower sound levels when operated at various frequencies compared to conventional blades.

TABLE 1
Vibration Measurement Acceleration R.M.S. Results

| Blade Type | Vibration Acceleration (m/s²) |
|---|---|
| Conventional Blade | 0.5317 |
| Exemplary Blade | 0.4568 |

Although the example embodiments of the present disclosure have been described in detail with reference to the accompanying drawings, the present disclosure is not limited thereto and can be embodied in many different forms without departing from the technical concept of the present disclosure. Therefore, the example embodiments of the present disclosure are provided for illustrative purposes only but not intended to limit the technical concept of the present disclosure. The scope of the technical concept of the present disclosure is not limited thereto. Therefore, it should be understood that the above-described example embodiments are illustrative in all aspects and do not limit the present disclosure. The protective scope of the present disclosure should be construed based on the following claims, and all the technical concepts in the equivalent scope thereof should be construed as falling within the scope of the present disclosure.

What is claimed is:

1. A saw blade for a powerable circular saw comprising:
a circular blade including an outer circumferential surface, the outer circumferential surface including a plurality of cutting edges;
an inner circumferential surface defining a central aperture, the central aperture being configured to fix the blade on a rotatable shaft of the circular saw; and
at least one resilient member located between the shaft and the inner circumferential surface, the at least one resilient member being configured to provide resilience between the inner circumferential surface and the shaft.

2. The saw blade of claim 1, wherein the at least one resilient member is a spring.

3. The saw blade of claim 1 comprising;
an outer core, the outer circumferential surface and the central aperture located on the outer core;
an inner core located within the central aperture of the outer core, the inner core including a bore configured to retain the shaft, wherein the resilient member is located between the inner core and outer core.

4. The saw blade of claim 3, wherein the inner core includes:
a central portion having a plurality of first teeth extending radially outward and configured to transmit a torque of the shaft to the blade; and
a plurality of first gap portions located between the teeth and configured to retain the at least one resilient member.

5. The saw blade of claim 4, wherein the inner circumferential surface includes;
a plurality of second teeth that correspond to and engage the plurality of first gap portions; and
a plurality of second gap portions that correspond to and engage the plurality of first teeth.

6. The saw blade of claim 4, wherein the at least one resilient member is a leaf spring having an arced section and first and second fixed sections at respective first and second terminal ends, the first and second fixed sections being fixed to the gap portions.

7. The saw blade of claim 6, wherein each gap portion includes a groove provided at each opposite end, the first and second fixed sections being tabs inserted in the grooves.

8. The saw blade of claim 1, further comprising;
a first hub located on a first side of the inner core; and
a second hub located on a second side of the inner core opposite to the first side, wherein the first hub and the second hub are configured to retain the at least one resilient member on the saw blade.

9. The saw blade of claim 8, wherein the hubs are larger than the central aperture.

10. The saw blade of claim 8, wherein the hubs are welded to the inner core.

11. A powerable circular saw comprising:
a circular saw blade including an outer circumferential surface, the outer circumferential surface including a plurality of cutting edges;
a central aperture having an inner circumferential surface, the central aperture being configured to fix the blade on a rotatable shaft of the circular saw; and
at least one resilient member located between the shaft and the inner circumferential surface, the at least one resilient member being configured to provide resilience between the inner circumferential surface and the shaft.

12. The circular saw claim 10, wherein the at least one resilient member is a spring.

13. The circular saw of claim 9 comprising;
an outer core, the outer circumferential surface and the central aperture located on the outer core;
an inner core located within the central aperture of the outer core, the inner core including a bore configured to retain the shaft, wherein the resilient member is located between the inner core and outer core.

14. The circular saw of claim 13, wherein the inner core includes:
a central portion having a plurality of first teeth extending radially outward and configured to transmit a torque of the shaft to the blade; and
a plurality of first gap portions located between the teeth and configured to retain the at least one resilient member.

15. The circular saw of claim 14, wherein the inner circumferential surface includes;
a plurality of second teeth that correspond to and engage the plurality of first gap portions; and
a plurality of second gap portions that correspond to and engage the plurality of first teeth.

16. The circular saw of claim 14, wherein the at least one resilient member is a leaf spring having an arced section and first and second fixed sections at respective first and second terminal ends, the first and second fixed sections being fixed to the gap portions.

17. The circular saw of claim 16, wherein each gap portion includes a groove provided at each opposite end, the first and second fixed sections being tabs inserted in the grooves.

18. The circular saw of claim 11, further comprising;
a first hub located on a first side of the inner core;
a second hub located on a second side of the inner core opposite to the first side, wherein the first hub and the second hub are configured to retain the at least one resilient member on the saw blade.

19. A tool head for a powerable power tool comprising:
a circular working disk including an outer circumferential surface, the outer circumferential surface including a plurality of work edges;
an inner circumferential surface defining a central aperture, the central aperture being configured to fix the blade on a rotatable shaft of the circular working disk; and
at least one resilient member located between the shaft and the inner circumferential surface, the at least one resilient member being configured to provide resilience between the inner circumferential surface and the shaft.

20. The tool head of claim 19, wherein the working disk is one of a grinder or a sander.
